(19) United States
(12) Patent Application Publication
(10) Pub. No.: US 2014/0359323 A1
(43) Pub. Date: Dec. 4, 2014

(54) SYSTEM AND METHOD FOR CLOSED LOOP PHYSICAL RESOURCE CONTROL IN LARGE, MULTIPLE-PROCESSOR INSTALLATIONS

(71) Applicants: Mark Fullerton, Austin, TX (US); Christopher Carl Ott, Austin, TX (US); Mark Bradley Davis, Austin, TX (US); Arnold Thomas Schnell, Pflugerville, TX (US)

(72) Inventors: Mark Fullerton, Austin, TX (US); Christopher Carl Ott, Austin, TX (US); Mark Bradley Davis, Austin, TX (US); Arnold Thomas Schnell, Pflugerville, TX (US)

(73) Assignee: SMOOTH-STONE, INC. C/O BARRY EVANS, Austin, TX (US)

(21) Appl. No.: 12/889,721

(22) Filed: Sep. 24, 2010

Related U.S. Application Data
(60) Provisional application No. 61/245,592, filed on Sep. 24, 2009.

(51) Int. Cl. G06F 1/32; G06F 1/26

(52) U.S. Cl. 713/320; 713/300

(57) ABSTRACT

A system and method for closed loop power supply control in large, multiple processor installations are provided.

### PRIORITY CLAIMS/RELATED APPLICATIONS

This patent application claims the benefit under 35 USC 119(e) and priority under 35 USC 120 to U.S. Provisional Patent Application Ser. No. 61/245,592 filed on Sep. 24, 2009 and entitled “System and Method for Closed Loop Power Supply Control in Large, Multiple-Processor Installations”, the entirety of which is incorporated herein by reference.

### FIELD

The disclosure relates generally to closed loop physical resource control for multiple processor installations.

### BACKGROUND

Large server systems (often call server farms) and some other applications employ a large number of processors. There are multiple physical resources and environmental constraints that affect the operation of these server farms, including power supply and power management, thermal management and limitations, fan and cooling management, and potential acoustic limits. Usually these physical resources such as power supplies and fans are significantly over-designed. Typically, power supplies and fans are allocated to supply each processor running at some high fraction of a peak load. In addition, some redundancy is added so that in the event that one power supply module or fan fails enough power or cooling capacity exists to keep the system running. Thus on one hand, there is a desire to have maximum computing performance available; on the other hand, there are limits, due to heat generation and supply of power, to what can actually be made available. Always, there is a connectedness among temperature, power, and performance. Typically, a larger-than-usually-needed supply sits ready to provide power needed by the CPUs, thus running most of the time at a low utilization, inefficient operating point. Also, a certain amount of headroom of power needs to be available, to maintain regulation during instantaneous increased demand. Additionally, power supplies need to be over-sized to respond to surge demands that are often associated with system power-on, where many devices are powering up simultaneously.

Thus, it is desirable to provide a system and method for closed loop physical resource control in large, multiple-processor installations and it is to this end that the disclosure is directed. The benefit of this control is relaxation of design requirements on subsystems surrounding the processor. For example, if the processor communicates that it needs maximum instantaneous inrush current, the power supply can activate another output phase so that it can deliver the needed inrush current. After this new current level averages out from the peak of inrush current, the power supply can deactivate the output phases in order to run at peak efficiency. In another example, when the processor predicts an approaching peak workload, it can communicate to the cooling subsystem its need for extra cooling to bring itself lower in its temperature range before the peak workload approaches. Likewise, if the system fans are running less than optimal to meet acoustic requirements, detection of departure of datacenter personnel (e.g. through badge readers) can cause the system to optimize the fans beyond the acoustic limit to some degree. Additionally upon detection of certain external power limit conditions such as, but not limited to brownout, or battery backup engaged, CPU throttling can immediately be implemented in order to maximize available operational time to either perform at reduced capacity or effect a hibernation state.

### BRIEF DESCRIPTION OF THE DRAWINGS

FIG. 1 illustrates an exemplary system for management of power supplied to multiple processors;

FIG. 1a illustrates an exemplary hierarchy of server processors, boards, shelves, and racks within a data center.

FIG. 1b illustrates an exemplary hierarchy of power supplies and regulators across a server rack.

FIG. 1c illustrates an exemplary hierarchy of cooling and fans across a server rack.

FIG. 1d illustrates an exemplary communication fabric topology across server nodes.

FIG. 2 illustrates an exemplary data structure that may be maintained by a power management system shown in FIG. 1;

FIG. 3 an example of a process for power management;

FIG. 4 illustrates an example of a larger power management system; and

FIG. 5 illustrates an exemplary process for system level power management.

### DETAILED DESCRIPTION OF ONE OR MORE EMBODIMENTS

What is needed is a system and method to manage the supply of power and cooling to large sets of processors or processor cores in an efficient, closed-loop manner such that rather than the system supplying power and cooling that may or may not be used, a processor would request power and cooling based on the computing task at hand, which request would then be sent to the central resource manager, and then to the power supply system and thus power made available. Further needed is bidirectional communication between the CPU(s), the central resource managers, and the power supplies stating it has a certain limit, and rather than giving each processor its desired amount of power, said system may give a processor an allocation based on prorated tasks. Additionally needed is a method of prioritization that may be used to reallocate power and cooling among processors, so the allocation does not have to be a linear cut across the board, and allows the resources (power supplies, fans) to not only limit, but to potentially switch units on and off to allow individual units to stay within their most efficient operating ranges.

The examples of the resources below in this disclosure are power, cooling, processors, and acoustics. However, there are many other resource types, such as individual voltage levels to minimize power usage within a circuit design, processor frequency, hard drive power states, system memory bus speeds, networking speeds, air inlet temperature, power factor correction circuits within the power supply, and active heat sinks and these resource types also can benefit from CRM functions by relaxing their expected performance as demanded by today's CPU's. In addition, the resource control technology described below for use in servers and data centers also may be used in other technologies and fields since the resource control technology may be used for solar farms for storage and recovery of surplus power where the utility grid or a residential “load” is the targeted application and those other uses and industries are within the scope of this disclosure.

Some of the leading processor architectures have a thermal management mode that can force the processor to a lower power state; however none at present time imposes similar power reduction dynamically based on the available power resources of the system as they assume that sufficient power is always available. Likewise, none at present time allow the fan speed to increase beyond an acoustic limit for a short duration to handle peak loads or for longer durations if humans are not present.

Fan speed and its effect on acoustic limits is a good example where a resource can be over-allocated. Typically, server subsystems are designed in parallel; each one having extra capacity that is later limited. For example, acoustic testing may place a fan speed limitation at 80% of the fan speed maximum. Since acoustics are specified based on human factor studies, not a regulatory body, violation of the acoustic limit by using the fan speed range between 80% to 100% may be acceptable in some cases. For example in a datacenter environment, acoustic noise is additive across many systems, so it may be permissible for a specific system to go beyond its acoustic limit without grossly affecting the overall noise levels. Often, there are particular critical systems, such as a task load balancer, that may experience a heavier workload in order to break up and transfer tasks to downstream servers in its network. This load balancer could be allowed to exceed its acoustic limit, knowing that the downstream servers can compensate by limiting their resources.

Like acoustics, the load balancer may also get over-allocated resources for network bandwidth, cooling air intake, or many other resources. Continuing with the above example to depict a tradeoff between processors, let the load balance processor run above its acoustic limit and run at its true maximum processing performance. Two rack-level resources need to be managed: rack-level power and room temperature. Typically, a server rack is designed with a fixed maximum power capacity, such as 8 KW (kilowatts). Often this limitation restricts the number of servers that can be installed in the rack. It is common to only fill a 42 U rack at 50% of its capacity, because each server is allowed to run at its max power level. When the load balance processor is allowed to run at maximum, the total rack power limit may be violated unless there is a mechanism to restrict the power usage of other servers in the rack. A Central Resource Manager can provide this function by requiring each processor to request allocation before using it. Likewise, while the load balancer exhausts extra heat, other processors in the rack can be commanded to generate less heat in order to control room temperature.

Each processor typically can run in a number of power states, including low power states where no processing occurs and states where a variable amount of execution can occur (for example, by varying the maximum frequency of the core and often the voltage supplied to the device), often known as DVFS (Dynamic Voltage and Frequency Scaling). This latter mechanism is commonly controlled by monitoring the local loading of the node, and if the load is low, decreasing the frequency/voltage of the CPU. The reverse is also often the case: if loading is high, the frequency/voltage can be increased. Additionally, some systems implement power capping, where CPU DVFS or power-off could be utilized to maintain a power cap for a node. Predictive mechanisms also exist where queued transactions are monitored, and if the queue is short or long the voltage and frequency can be altered appropriately. Finally, in some cases a computational load (specifically in the cloud nature of shared threads across multiple cores of multiple processors) is shared between several functionally identical processors. In this case it's possible to power down (or move into a lower power state) one or more of those servers if the loading is not heavy.

Currently there is no connection between power supply generation to the processors and the power states of each processor. Power supplies are provisioned so that each processor can run at maximum performance (or close to it) and the redundancy supplied is sufficient to maintain this level, even if one power supply has failed (in effect double the maximum expected supply is provided). In part, this is done because there is no way of limiting or influencing the power state of each processor based on the available supply.

Often, this is also the case for fan and cooling designs, where fans may be over-provisioned, often with both extra fans, as well as extra cooling capacity per fan. Due to the relatively slow changes in temperature, temperatures can be monitored and cooling capacity can be turned changed (e.g., increase or slow fans). Based on the currently used capacity, enough capacity must still be installed to cool the entire system with each system at peak performance (including any capacity that might be powered down through failure or maintenance).

In effect, the capacity allocated in both cases must be higher than absolutely necessary, based on the inability to modulate design when capacity limits are approached. This limitation also makes it difficult to install short-term peak clipping capacity that can be used to relieve sudden high load requirements (as there is no way of reducing the load of the system when it is approaching the limits of that peak store). As an example, batteries or any other means of storing an energy reserve could be included in the power supply system to provide extra power during peaks; however, when they approach exhaustion the load would need to be scaled down. In some cases, cooling temperatures could simply be allowed to rise for a short period.

Given closed loop physical resource management, it is possible to not over-design the power and cooling server subsystems. Not over-designing the power and cooling subsystems have a number of key benefits including:
More cost effective systems can be built by using less expensive, and potentially fewer power supplies and fans.
Using fewer power supplies and fans can increase the MTBF (mean-time between failures) of a server.
Using fewer and less powerful power supplies and fans can provide significant savings in energy consumption and heat generation.
The closed loop physical resource management provides the server farm system administration a great deal of control of balancing performance and throughput, with the physical and environmental effects of power consumption, heat generation, cooling demands, and acoustic/noise management.
A transition from local, myopic limits and management on physical resources to globally optimized physical and environmental management.
The ability to handle short duration, peak surges in power and cooling demands without the traditional significant over-design of the power and cooling subsystems.
The ability to run the power supplies and fans near their most efficient operating points, rather than today especially the power supplies tend to run at very inefficient operating points because of the over-design requirements.
The ability to integrate predictive workload management in a closed loop with power and fan resource management.

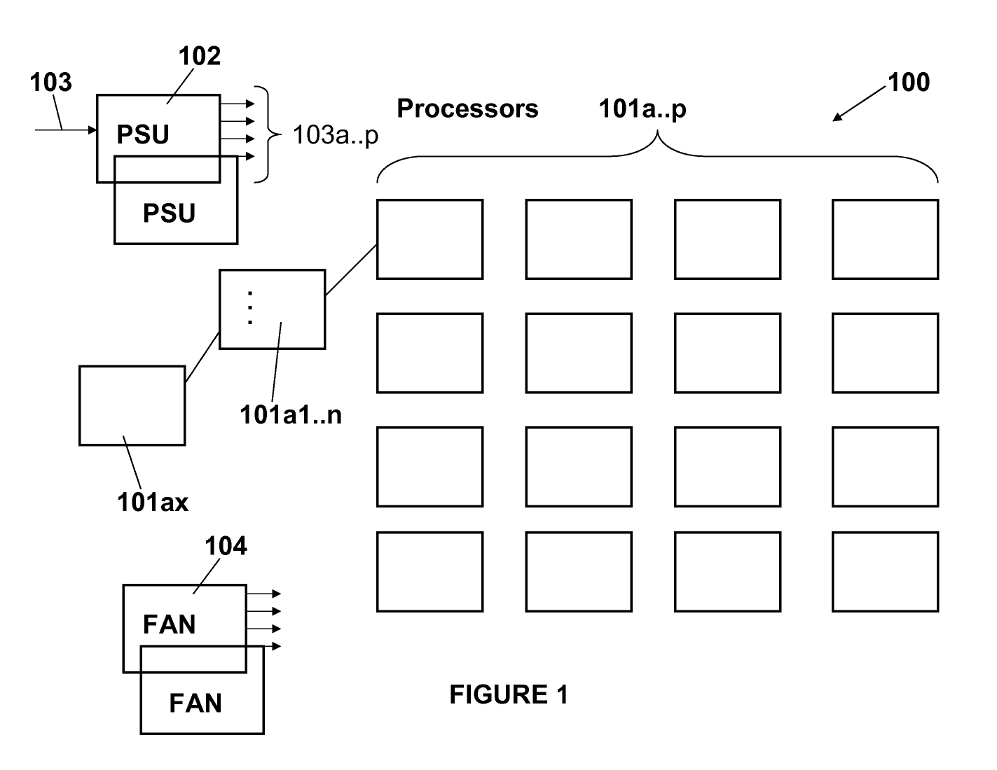

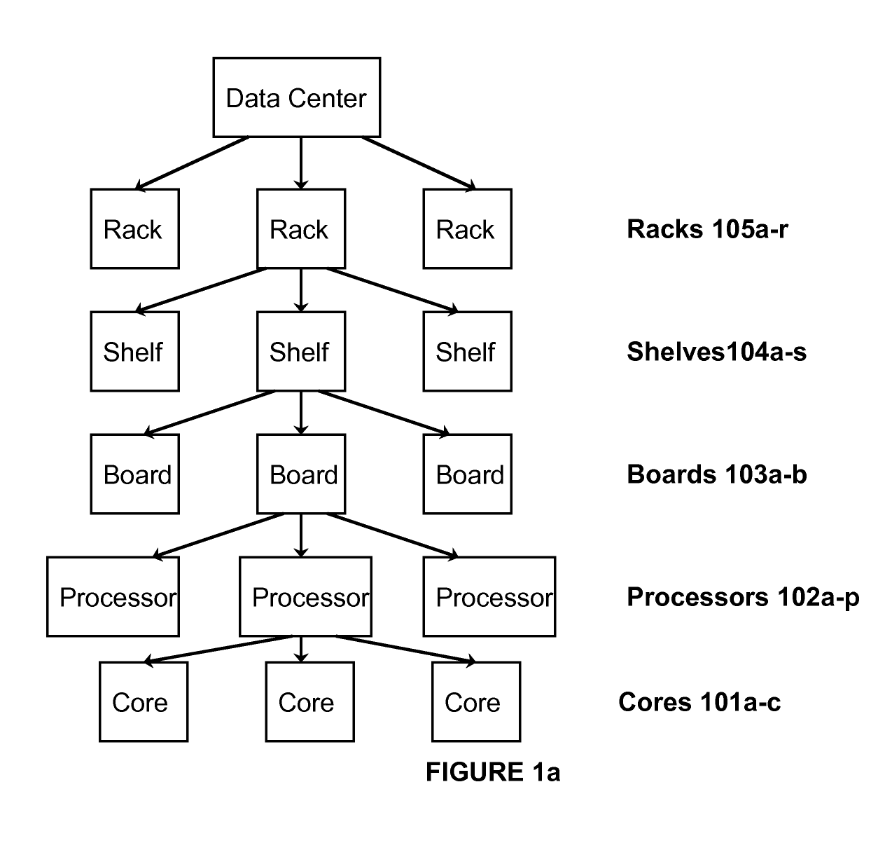

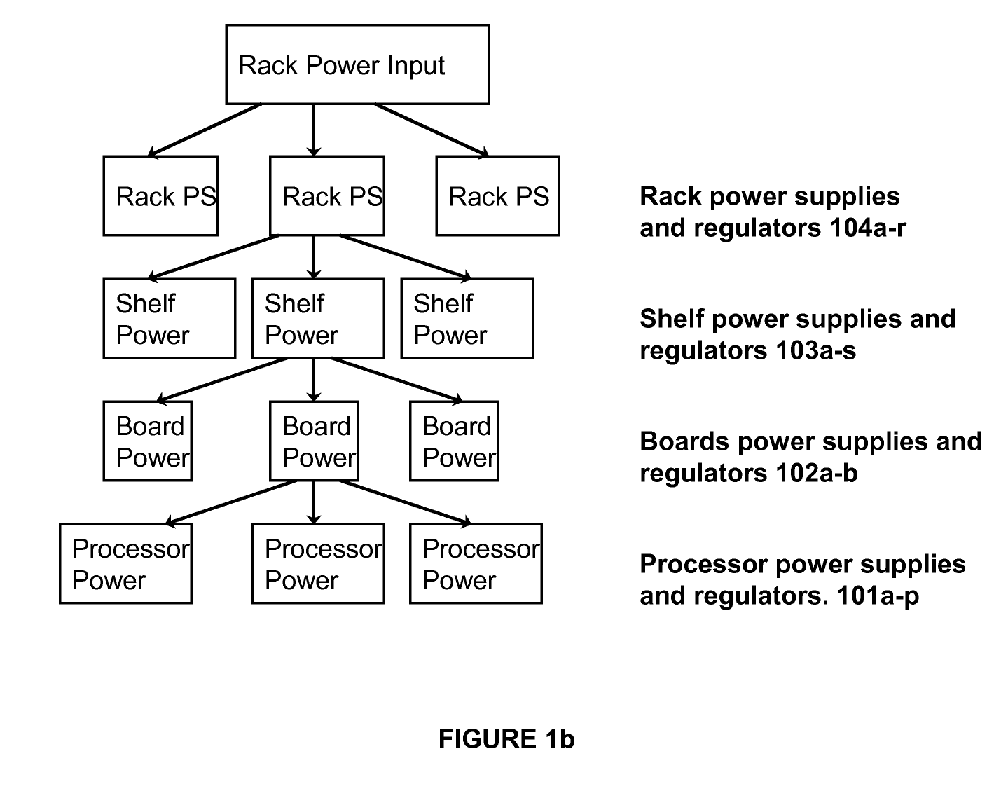

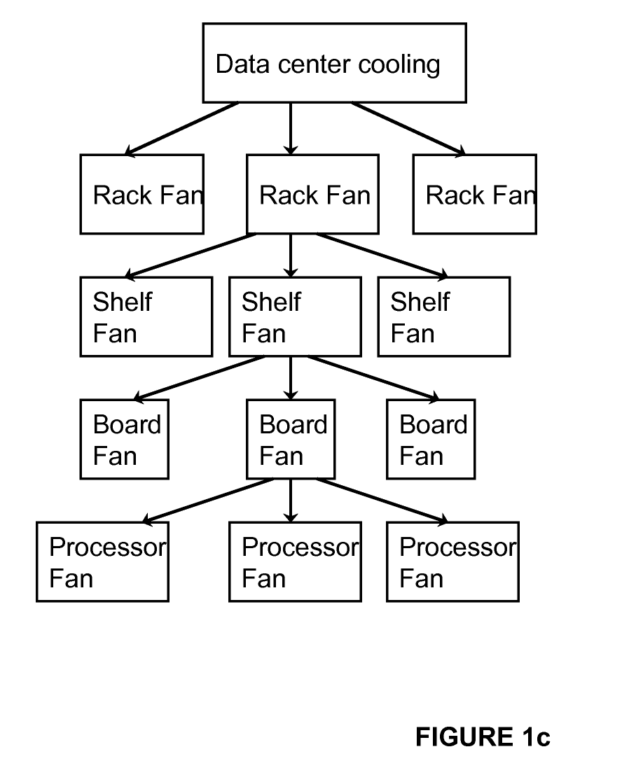

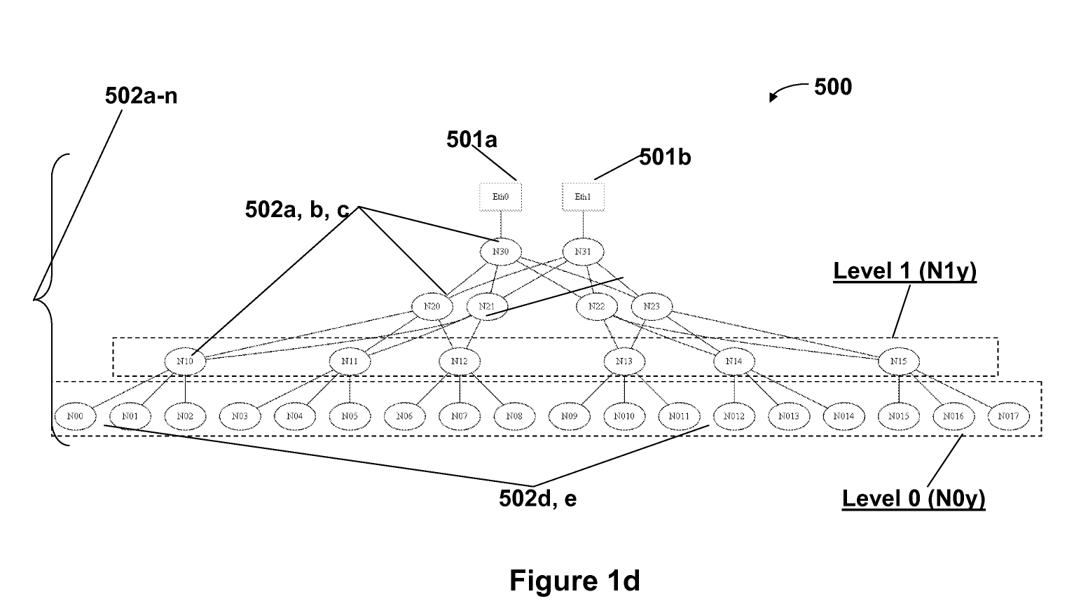

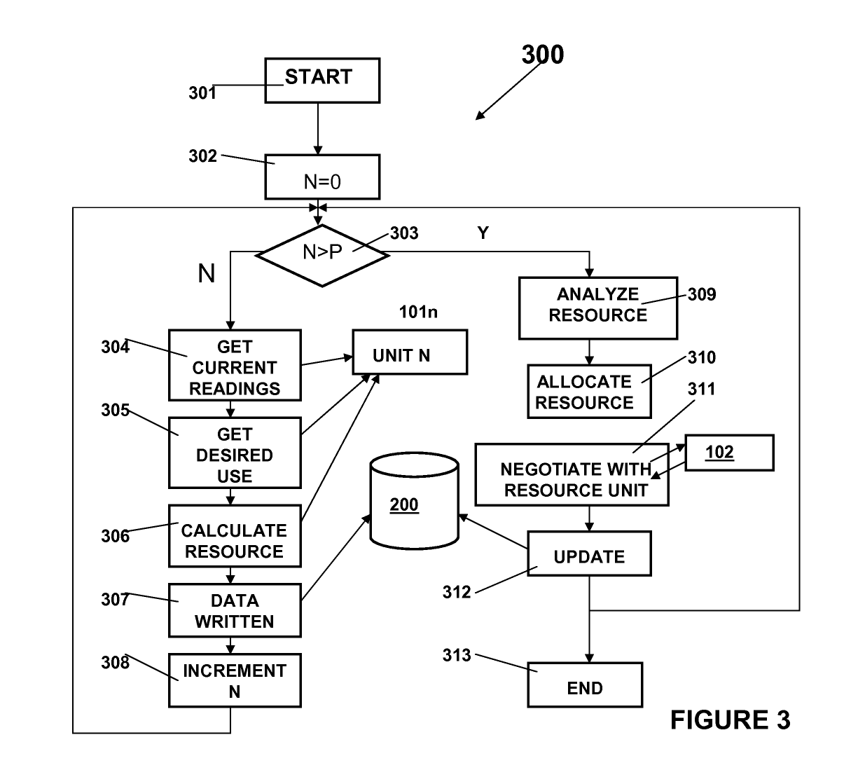

FIG. 1 shows an overview of an exemplary system 100 for management of power supplied to multiple processors according to one embodiment. The system 100 has an array of processors (such as 16 processors 101a-p as shown in FIG. 1.) Each processor has its own complete computing system, with memory and communication interconnection buses, a power feed, etc. All of these elements of each processor's system are well known in current art and are not shown here, for reasons of simplicity and clarity. Processor 101a has an operating system with multiple programs 101a1-n. One of these programs, 101ax, is of particular interest and may be known as a Central Resource Manager (CRM). It is the software component that has a plurality of instructions and that communicates with the system management software, described in greater detail in the discussion of FIG. 3, below. The system management software can actually run on any one of the processors 101a-p, or it can run on a separate, dedicated processor (not shown). One or more power supply units (PSU) 102 gets a main power feed 103 and distributes it through subfeeds 103a-p to each of the processors 101a-p according to their individual needs. One or more fans 104 also provide air movement and cooling for the processors. In some cases more than one processor 101b-p can have similar software/programs 101b1-n through 101p1-n, including 101bx-px that can communicate with the system management software which is not shown in FIG. 1 for reasons of clarity.

FIG. 1a illustrates that physical resources within a data center have inherent hierarchy. These hierarchies may take different forms, but a common server structural data center hierarchy shown in FIG. 1a has:
One or more processor CPUs 102 compositing one or more processor cores 101
One or more server boards 103 compositing one or more processors 102
One or more server shelves 104 compositing one or more server boards 103
One or more server racks 105 compositing one or more server shelves 104
Data centers compositing one or more server racks 105

FIG. 1b shows that power supply and regulation can also be thought of hierarchically through the data center. Individual processors require 1 or more voltage/power feeds 101a-p. These feeds may be either static, or dynamically adjustable. Also these feeds may have power gating associated with them to allow software to enable/disable the feeds to the processors. A server board may have power supplies/regulators that feed all or some of the processors on the board, as well as processors may have regulators associated individually with processors. Shelves may have power supplies or regulators at the shelf level. Racks may have one or more power supplies or regulators feeding the servers across the rack.

FIG. 1c illustrates that fans and cooling can also be thought of hierarchically through the data center. Processors may have fans associated with the individual processors, often integrated into the heat sink of the processor. Boards may have one or more fans for air movement across the board. Shelves may have one or more fans for air movement across the shelf. Racks may have one or more fans throughout the rack.

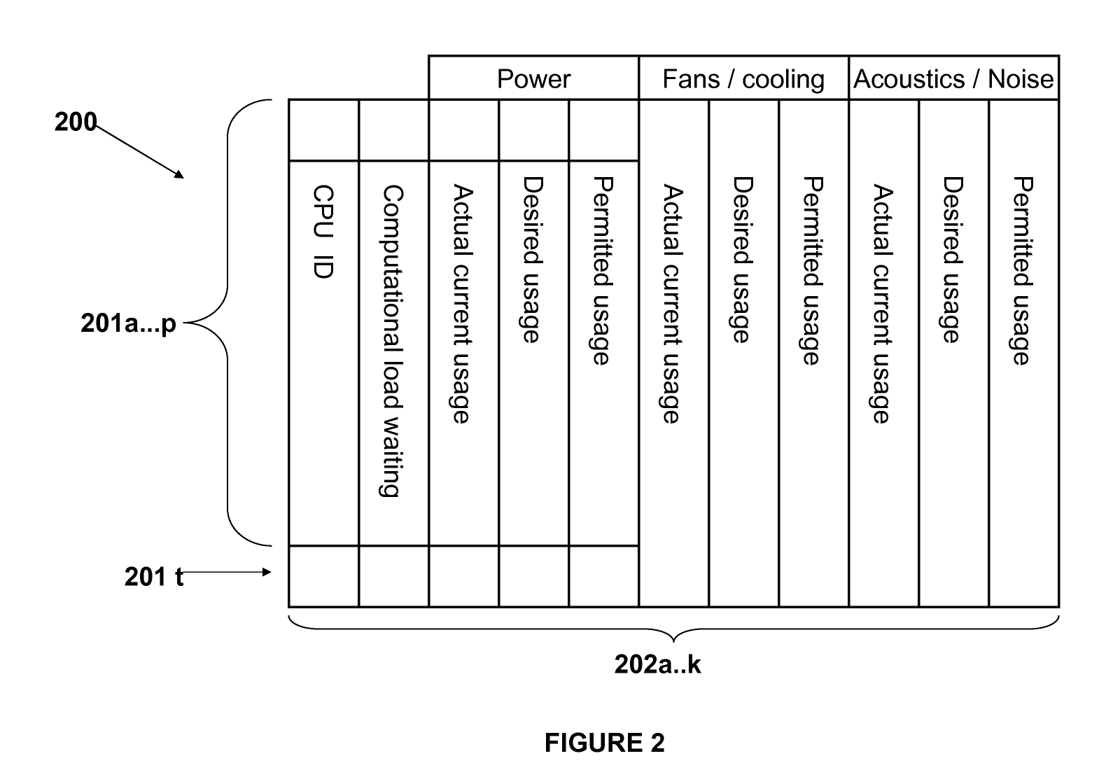

FIG. 1 d illustrates that individual server nodes may also have a structural topology. Common topologies include meshes or tree-like organizations. FIG. 1d shows a high-level topology 500 of the network fabric connected server nodes. The Ethernet ports Eth0 501a and Eth1 501b come from the top of the tree. Ovals 502a-n is server nodes that comprise both computational processors as well as an embedded networking switch. FIG. 2 shows an exemplary data structure 200, such as a table that could be maintained by a resource management system such as management system 100, for example, as described in FIG. 1. Each row 201a-p contains records of parameters 202a-e that are recorded in columns. They may be updated from time to time as necessary, either if certain changes occur or on an interval basis, etc. It is clear that the five parameters 202a-k are only exemplary of any of a great variety of parameters that may be included in data structure 200, so the number of parameters is not restricted to those illustrated. In this example, parameters are (reading left to right):
CPU ID
the computational load waiting, for example, processes waiting in queue, with an additional priority rating in some cases (not shown)
Power related utilizations including actual current usage, desired usage based on tasks awaiting execution by the CPU, and permitted usage allocated to the CPU at the moment
Fan and cooling related utilizations including, actual current usage, and desired usage based on tasks awaiting execution by the CPU, and permitted usage allocated to the CPU at the moment.
Acoustics and noise related utilizations including, actual current usage, desired usage based on tasks awaiting execution by the CPU, and permitted usage allocated to the CPU at the moment
A record 201t sums up the total of the parameter records of rows 201a-p for array 101a-p. Each processor in array 101a-p may actually be a chip containing multiple CPUs or multiple cores of its own, so, in the case of array 101a-p, the actual number of processors involved may be, for example, 256, instead of 16, if each chip were to contain 16 cores.

The exemplary data structure shows a single record 201t summing usages and utilizations across processors into a single sum is a simple approach to aid understanding of the overall strategy. More refined implementations will contain data structures that encode the server hardware topologies illustrated in FIG. 1a, the power supply and regulation hierarchies illustrated in FIG. 1b, the fan and cooling hierarchies illustrated in FIG. 1c, and the server interconnect topologies illustrated in FIG. 1d.

Usage, request, and utilization sums in more sophisticated systems would be done at each node of the aggregation hierarchies. As an example, power usage, request, and utilization sums would be done in a tree fashion at each node of the tree illustrated in FIG. 1b. Fan usage, request, and utilization sums would be done in a tree fashion at each node of the tree illustrated in FIG. 1c.

FIG. 3 shows an exemplary process 300 of the management software executed in any one of the processors of array 101a-p or in a dedicated processor (not shown), according to one embodiment. In step 301 the system starts, and in step 302 it starts a count of the number of process repetitions in one session. In step 303, the system checks to see whether the count exceeds a pre-set maximum, which in this example is P, the number of units in array 101a-p that must be addressed. It is clear that because P represents a number, there is no practical limitation to the numeric value of P. If the count does not exceed the set maximum (NO), in step 304 the system receives current readings from unit N, which in this example is chip 101n. In step 305, the system obtains the desired resource (e.g. power, fans,) usage, based on computational requirements and priority between the requirements, from each software instance 101yx. In step 306 the system calculates the resource allocation and returns it to the process. This resource allocation computation takes into account the resource hierarchies (e.g. the power and fan hierarchies) as described previously. In step 307 data about the exchanges in steps 304-306 is written to and/or read from a store 200 such as into the data structure shown in FIG. 2. In step 308, N is incremented and the process loops back to step 303 until all cores in the array have been addressed, in sequence. If, in step 303, the full sequence of units has been addressed and N becomes greater than P (YES), the process moves to step 309, where the system calculates for each resource (e.g. power) the quantity of the resource used, the desired resource utilization, and the available resource availability for all units that were addressed in steps 304-306. In step 310 resources are allocated, and in step 311 the system negotiates with external resource hardware such as Power supply unit 102 about available power or available additional power, and then in step 312 the system updates data in store 200. The process may end at step 313, and then it may start again based on some pre-set timer, triggered by a change in resource requirements or priorities, or other internal or external events. In other cases, the process may be set to continuously loop back to step 302. Additionally, algorithmically not all processors may be updated cyclically, but can be updated individually based upon events triggered with respect to that processor.

In the current system as described in the discussions of FIGS. 1 through 3, a system 100 has a resource allocation, such as power, that it needs to manage. Each processor is allocated a certain base capacity and must request more capacity from a central resource manager. In addition, the central resource manager can signal the processor that it requires it to release capacity (either urgently or more slowly). It is clearly possible for the central resource manager to be duplicated for redundancy and for the managers to remain synchronized. Note that because the resource manager controls the power state of the processor it can alter the actual load that is imposed; hence the available system capacity can be used to alter the power state of the processor. This feature is key to the system, as the system can never over allocate capacity without running the risk of a “brown out.” In addition, the current system permits consideration of a situation where an amount of capacity is only allocated for a fixed period of time and must be renewed periodically.

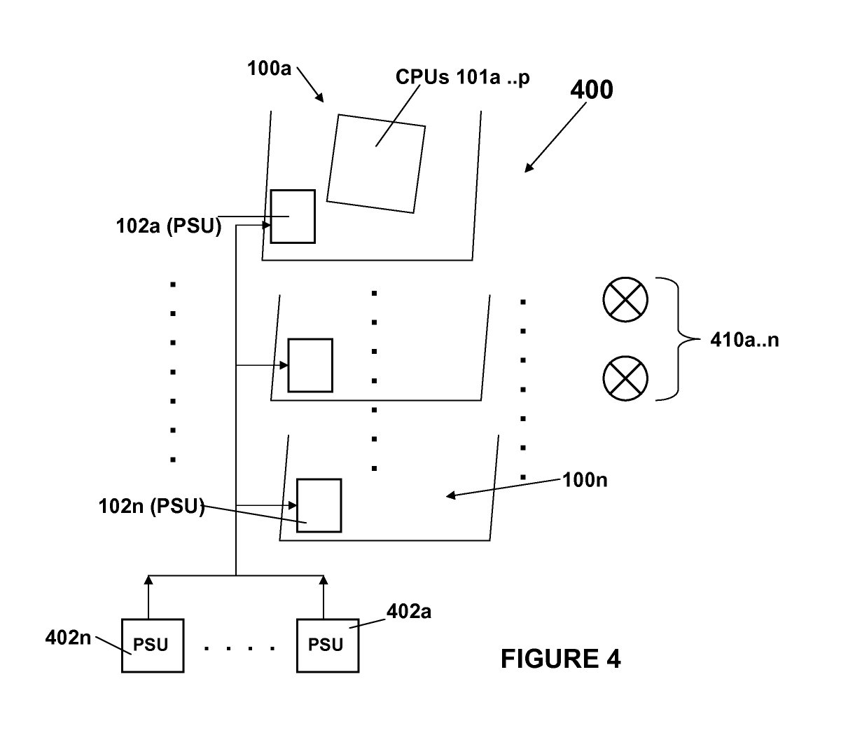

FIG. 4 shows a simplified overview of an exemplary larger power management system 400. In this example, multiple installations, typically printed circuit boards, of the type of system shown as system 100 are stacked vertically (although it is clear that such system multiples may be arranged vertically, horizontally, sequentially, networked, or in any other way). Each system 100a-n has CPUs 101a-p and PSU 102, so that in system 400 there are PSUs 102a-n. System 400 also contains air conditioning or cooling and heat sensors 410a-n and master PSUs 402a-n. In this example, the variable range a-n for PSU 402a-n simply indicates a variable, finite numeric quantity, and should not be construed to be an exact number. Depending on the total requirements of PSUs 102a-n, a variable number of PSUs 402a-n may be turned on or turned off, thus keeping the system running optimally and reducing problems of overheating.

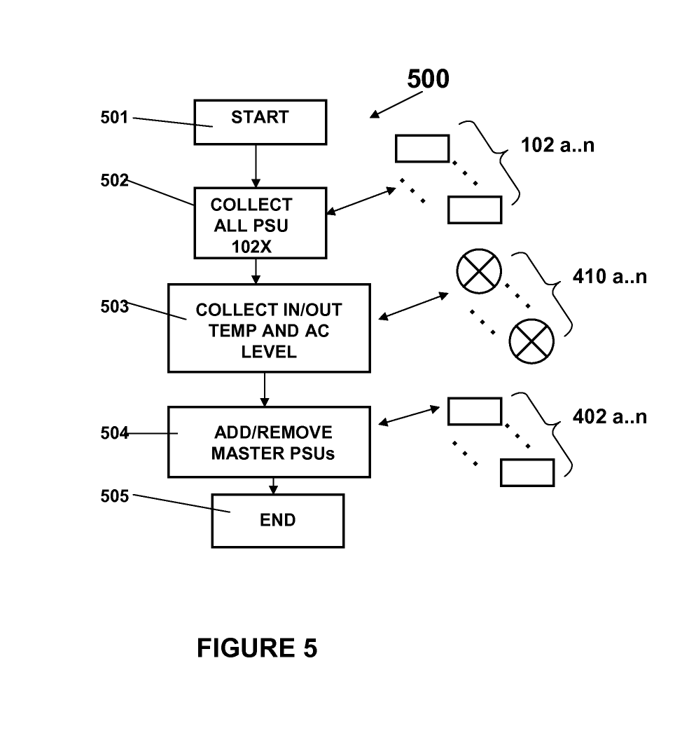

FIG. 5 shows an exemplary process 500 of the system-level management software, according to one embodiment. In essence, process 500 is similar to process 300. Additionally incorporated are controls of the air conditioning or cooling and heat sensors 410a-n. In step 501 the system starts, and in step 502, it collects all data from PSU 102a-n. In step 503 the system assesses outside and inside temperatures of each PSU 102a-n and the current heat loads, as well as available air conditioning or cooling performance. In step 504 additional main PSUs are accordingly added or removed, and new power ceilings are distributed to CPUs 101a-n. In step 505 the process ends.

In some cases several of the nodes in a system may require greater performance (based on loading). The individual power managers request capacity and it is granted by the central resource manager (CRM) (for example, 50 nodes request 5 units of extra capacity allowing full execution). If other nodes request the same capacity, the CRM can similarly grant the request (assuming that the peak loads do not align, or it may over allocate its capacity). The CRM is implementing the process shown in FIG. 3 and the CRM may be implemented on any node, such as node 101ax implements the CRM process.

In the event of a power supply failure, the CRM detects the power supply failure. The system may have an energy reserve. The energy reserve may be a backup battery, or any other suitable energy reserve, including but not limited to mechanical storage (flywheel, pressure tanks etc.) or electronic storage (all types of capacitors, inductors etc.) that is capable of supplying power for a deterministic duration at peak load, so the CRM has adequate time to reduce the capacity to the new limit of 450 units (actually it has double that this time if the battery can be fully drained, because part of the load may be supplied by the single functioning power supply). The CRM signals each power controller in each processor that it must reduce its usage quickly. This operation takes a certain amount of time, as typically the scheduler needs to react to the lower frequency of the system; however, it should be achievable within the 100 ms. After this point each processor is going to be running at a lower capacity, which implies slower throughput of the system (each processor has 4.5 units of capacity, which is enough for minimum throughput).

Further adjustment of the system can be done by the CRM requesting capacity more slowly from some processors (for example moving them to power down states) and using this spare capacity to increase performance in nodes that are suffering large backlogs. In addition, in an aggressive case, the energy reserve can have some of its energy allocated for short periods to allow peak clipping (the processor requests increase capacity and is granted it, but only for a few seconds).

A similar mechanism can be used to allocate cooling capacity (although the longer time constants make the mechanism easier).

A less aggressive system can allocate more total power and have more capacity after failure; while more aggressive systems can allocate less total power and not allow all processors to run at full power even in the situation where redundancy is still active. More complex redundancy arrangements can be considered (e.g., N+1), etc. The key is that capacity is allocated to different processors from a central pool and the individual processors must coordinate their use.

For a system where the individual processors are smaller and have better low power modes (i.e., bigger differences between high and low power) this approach is even more applicable.

Communication to the CRM can be done by any mechanism. The requirement is that it must be quick so that the failure case time constant can be met, at least for most of the nodes. It's likely that Ethernet packets or messages to board controllers are sufficient.

Additionally when the CRM is making allocations of resources to processors, the encoded processor communication topologies illustrated in FIG. 1 d, as well as the encoded hierarchical processor implementations illustrated in FIG. 1a can be taken into account to optimize resource allocations globally across a rack. As an example, a shelf or subtree can be powered off or slowed down to meet the overall resource management goals of the rack.

It is clear that many modifications and variations of this embodiment may be made by one skilled in the art without departing from the spirit of the novel art of this disclosure. These modifications and variations do not depart from the broader spirit and scope of the disclosure, and the examples cited here are to be regarded in an illustrative rather than a restrictive sense.

1. A multi-processor based system, comprising:
a plurality of processors;
one or more controllable resources;
a resource control program for execution on at least one of the plurality of processors; and
wherein the resource control program has instructions to determine a need for computation at each processor of the plurality of processors, instructions to determine at least a subset of the one or more controllable resources that meet the need for computation of each processor based on at least a location of the processor on a board in a data center, and instructions to allocate respective subsets of the one or more controllable resources to each processor to meet the need for computation for each processor.

2. The system of claim 1, wherein the one or more controllable resources further comprises one or more controllable power supply units and wherein the resource control program further comprises instructions to activate a particular controllable power supply unit to increase power supplied to the plurality of processors.

3. The system of claim 1, wherein the plurality of processors and the one or more controllable resources are located in a plurality of server boards.

4. The system of claim 3, wherein the one or more controllable resources further comprises one of one or more controllable power supply units, one or more controllable cooling resources, and one or more controllable acoustic resources that are distributed across the plurality of server boards.

5. The system of claim 1, wherein the resource control program further comprises instructions that allocate less than the subset of the one or more controllable resources to prevent over allocation of the one or more controllable resources.

6. The system of claim 5, wherein the resource control program further comprises instructions to negotiate with each processor to determine the subset of the one or more controllable resources that meet the need for computation of each processor.

7. The system of claim 1, wherein the resource control program further comprises instructions to allocate the respective subsets of the one or more controllable resources to handle short duration surge requests by each processor.

8. The system of claim 1, wherein the resource control program further comprises instructions to allocate the respective subsets of the one or more controllable resources based on a time for the one or more controllable resources to ramp up to meet the need for computation for each processor.

9. A method for supplying resources to a multi-processor based system, the method comprising:
determining, by a resource control program, a need for computation at each processor of a plurality of processors;
determining, by the resource control program, a subset of the one or more controllable resources that meets the need for computation of each processor based on at least a location of the processor on a board in a data center; and
allocating, by the resource control program, respective subsets of the one or more controllable resources to each processor to meet the need for computation for each processor.

10. The method of claim 9, further comprising activating, by the resource control program, a controllable power supply unit to increase the power supplied to the plurality of processors.

11. The method of claim 9, further comprising deactivating, by the resource control program, a controllable power supply unit that is supplying power to the plurality of processors to reduce the power supplied to the plurality of processors.

12. The method of claim 9, wherein the plurality of processors and the one or more controllable resources are located in a plurality of server boards.

13. The method of claim 12, further comprising allocating, by the resource control program, one of one or more controllable power supply units distributed across the plurality of server boards, one or more controllable cooling resources distributed across the plurality of server boards, and one or more controllable acoustic resources distributed across the plurality of server boards to each processor to meet the need for computation for each processor.

14. The method of claim 9, wherein allocating the respective subsets of the one or more controllable resources further comprises allocating, by the resource control program, less than the subset of the one or more controllable resources to prevent over allocation of the one or more controllable resources.

15. The method of claim 14, further comprising negotiating, by the resource control program, with each processor to determine the respective subsets of the one or more controllable resources that meet the need for computation of each processor.

16. The method of claim 9, further comprising allocating, by the resource control program, the respective subsets of the one or more controllable resources to handle short duration surge requests by each processor.

17. The method of claim 9, wherein the allocating is based on a time for the one or more controllable resources to ramp up to meet the need for computation for each processor.

18. A multi-processor based system, comprising:
a plurality of processors, wherein the plurality of processors are located on one or more boards in a data center and each processor has a communication topology with another processor;
one or more controllable resources, wherein the one or more controllable resources are located on the one or more boards in the data center;
a resource control program for execution on at least one of the plurality of processors; and
wherein the resource control program has instructions to determine a need for computation at each processor of the plurality of processors, instructions to determine a subset of the one or more controllable resources that meet the need for computation of each processor based on at least a location of the processor on a board in the data center, and instructions to allocate respective subsets of the one or more controllable resources to each processor to meet the need for computation for each processor.

19. The system of claim 18, wherein the one or more controllable resources further comprises one or more controllable power supply units and wherein the resource control program further comprises instructions to activate a particular controllable power supply unit to increase power supplied to the plurality of processors.

20. The system of claim 18, wherein the resource control program further comprises instructions that allocate less than the subset of the one or more controllable resources to prevent over allocation of the one or more controllable resources.

21. The system of claim 20, wherein the resource control program further comprises instructions to negotiate with each processor to determine the respective subsets of the one or more controllable resources that meet the need for computation of each processor.

22. The system of claim 18, wherein the resource control program further comprises instructions to allocate the respective subsets of the one or more controllable resources to handle short duration surge requests by each processor.

23. The system of claim 18, wherein the resource control program further comprises instructions to allocate the respective subsets of the one or more controllable resources based on a time for the one or more controllable resources to ramp up to meet the need for computation for each processor.

24. The system of claim 18, wherein the one or more controllable resources are one of one or more controllable power supply units, one or more controllable cooling resources, and one or more controllable acoustic resources.

25. A method for supplying resources to a multi-processor based system, the method comprising:
determining, by a resource control program, a need for computation at each processor of a plurality of processors, wherein the plurality of processors are located on one or more boards in a data center, and wherein each processor has a communication topology with another processor;
determining, by the resource control program, a subset of one or more controllable resources that meet the need for computation of each processor based on at least a location of the processor on a board in the data center; and
allocating, by the resource control program, respective subsets of the one or more controllable resources to each processor to meet the need for computation for each processor.

26. The method of claim 25, further comprising activating, by the resource control program, a controllable power supply unit to increase power supplied to the plurality of processors.

27. The method of claim 25, further comprising deactivating, by the resource control program, a controllable power supply unit to reduce power supplied to the plurality of processors.

28. The method of claim 25, further comprising allocating, by the resource control program, one of one or more controllable power supply units, one or more controllable cooling resources, and one or more controllable acoustic resources to each processor to meet the need for computation for each processor.

29. The method of claim 25, wherein allocating the respective subsets of the one or more controllable resources further comprises allocating, by the resource control program, less than the respective subsets of the one or more controllable resources to prevent over allocation of the one or more controllable resources.

30. The method of claim 29, further comprising negotiating, by the resource control program, with each processor to determine the respective subsets of the one or more controllable resources that meet the need for computation of each processor.

31. The method of claim 25, further comprising allocating, by the resource control program, the respective subsets of the one or more controllable resources to handle short duration surge requests by each processor.

32. The method of claim 25, wherein the allocating is based on a time for the one or more controllable resources to ramp up to meet the need for computation for each processor.
